(19) United States
(12) Patent Application Publication
(10) Pub. No.: US 2025/0214906 A1
(43) Pub. Date: Jul. 3, 2025

(54) Method For Promoting The Growth Of Corn Under Low Temperature Stress

(71) Applicant: CH Biotech R&D Co., Ltd., Nantou City (TW)

(72) Inventors: Kai XIA, Nantou (TW); Ya-Wen HUANG, Taichung (TW); Gui-Jun LI, Taichung (TW)

(73) Assignee: CH Biotech R&D Co., Ltd., Nantou City (TW)

(21) Appl. No.: 18/748,493

(22) Filed: Jun. 20, 2024

(30) Foreign Application Priority Data
Dec. 29, 2023 (TW) 112151703

(51) Int. Cl. C05F 1/00; C05C 11/00

(52) U.S. Cl. CPC C05F 1/005; C05C 11/00

(57) ABSTRACT

Present invention teaches the method of using a keratin hydrolysis peptide (“KHP”) solution to improve the growth of corn under low temperature conditions. By selectively choosing specific weights of feathers and water, and treating the mixture to a high-temperature high-pressure hydrolysis process, the resulting solution is confirmed to contain at least 253 peptides and then infused to the soil containing the corn seeds, the solution can also be sprayed to the leaf surface of corn plants at a specific growth stage. Optionally, the KHP solution can be diluted by water, as disclosed in the specification, for applying to the soil and for spraying to leaf surface of corn seedlings/plants.

### PRIORITY CLAIM TO FOREIGN APPLICATION

Applicant hereby makes priority claim to a Taiwan application, number 112151703, having the Taiwan filing date of Dec. 29, 2023.

### SEQUENCE LISTING

Table I (in Sequence Listing XML format) shows the at least 253 peptides and its annotated sequences for the solution generated in accordance with the disclosure of this application. The Sequence Listing XML file complies with the WIPO ST.26 requirements. Said XML copy, created on Mar. 17, 2024, is named Table-I-253_sequence and is 216 bytes in size.

Applicant hereby incorporates by reference said Sequence Listing XML file in its entirety as part of the disclosure and specification of the present application

### BACKGROUND OF THE INVENTION

Present invention disclosed and claimed a method and application of a keratin hydrolysis peptide (“KHP”) solution to promote the growth of corn under low temperature stress.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

The KHP solution is made by a hydrolysis process using feathers and water, via a high-temperature and high-pressure process, resulting in a solution that has many beneficial applications in the fields of horticulture, agriculture and potentially other farming businesses.

Among the embodiments disclosed and claimed in this application, one specific embodiment used feathers only, without water, to be treated with the high-temperature and high-pressure process as taught herein to produce a specific version of the KHP solution.

Corn plants are partial to warmer climate, with the ideal germination temperature being in the range of between 29° C. and 32° C. In most corn growing regions, farmers are advised to plant corn seeds when the soil temperature is higher than 10° C., the reason being that low temperature environment is adverse to the proper and healthy development of corn, especially to young corn seedlings after germination. As such, it is well known that the low temperature stress to corn's growth can, ultimately, severely limit the production of corn.

Particularly, a period of low temperature (such as between March to May) in the early growth stages would negatively affect the seeds' growth after planting. Even if seedings are done timely, if the young corn seedlings encounter low temperature spells, its development will be stunted and the ultimate production yield will further be impacted.

The timing of the initial 24-72 hours after planting the seeds is critical because the seeds are absorbing water for the growth; encountering a low temperature spell at this critical time likely leads to cells rupture from the water absorbed, and thus affecting the proper germination, and causing early termination of the bud/shoot growth.

Once the germinated young shoots popped out from the soil, the low temperature spell would also impact the natural development of a corn plant. Early death of the corn plant come naturally as a result of a low temperature spell.

The present invention's KHP solution and the method of using same is a cost-effective way to improve the growth of corn due to the negative impact of low temperature adversity.

The inventors of present application conducted numerous tests and confirmed the effectiveness of applying the KHP solution as disclosed and claimed herein.

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of a-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed and selected different feather and water compositions to perform the hydrolysis at higher temperature and higher pressure settings, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The inventors used the Dionex UltiMate 3000 UPLC to separate the peptides; an analysis is done via Thermo Orbitrap Fusion Lumos Tribrid Orbitrap mass spectrometry to identify the peptides, which are then subsequently confirmed by looking up the BIOPEP-UWM database.

The solutions are infused to the soil containing the corn seeds; the soil infusion of the solutions can also be done during the seedling stage. Alternatively, the solutions can be sprayed to the leaf surface of the corn seedling during the V3-V4 growth stages.

The solution can be diluted by water, at 50 to 100 ratio (noted as 50× to 100×) by volume.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

FIG. 1 shows the comparison of underground bio mass weights among the low temperature groups vis-à-vis the normal temperature group.

FIG. 2A shows the comparison of plant heights among the low temperature groups vis-à-vis the normal temperature group.

FIG. 2B shows the comparison of stem widths among the low temperature groups vis-à-vis the normal temperature group.

FIG. 3A shows the comparison of above ground fresh weights among the low temperature groups vis-à-vis the normal temperature group.

FIG. 3B shows the comparison of above ground dry weights among the low temperature groups vis-à-vis the normal temperature group.

FIG. 4A shows the comparison of leaf surface areas among the low temperature groups vis-à-vis the normal temperature group.

FIG. 4B shows the comparison of SPAD reading (chlorophyll) from the third leaves among the low temperature groups vis-à-vis the normal temperature group.

FIG. 4C shows the comparison of SPAD reading (chlorophyll) from the fourth leaves among the low temperature groups vis-à-vis the normal temperature group.

FIG. 5 shows, given treatment of KHP solutions, both leaf-spray and soil infusion at V3-V4 stage, underground dry weights among the low temperature groups vis-à-vis the normal temperature group.

FIG. 6A shows, given treatment of KHP solutions, both leaf-spray and soil infusion at V3-V4 stage, above ground dry weights among the low temperature groups vis-à-vis the normal temperature group.

FIG. 6B shows, given treatment of KHP solutions, both leaf-spray and soil infusion at V3-V4 stage, the plant heights among the low temperature groups vis-à-vis the normal temperature group.

FIG. 6C shows, given treatment of KHP solutions, both leaf-spray and soil infusion at V3-V4 stage, the stem widths among the low temperature groups vis-à-vis the normal temperature group.

FIG. 7A shows, given treatment of KHP solutions, both leaf-spray and soil infusion at V3V4 stage, the leaf surface areas among the low temperature groups vis-à-vis the normal temperature group.

FIG. 7B shows, given treatment of KHP solutions, both leaf-spray and soil infusion at V3-V4 stage, the SPAD reading from the 5th leaves among the low temperature groups vis-à-vis the normal temperature group.

FIG. 7C shows, given treatment of KHP solutions, both leaf-spray and soil infusion at V3-V4 stage, the SPAD reading from the 6th leaves among the low temperature groups vis-à-vis the normal temperature group.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The mixture ratio, temperature, pressure and duration parameters are shown herein:

| | | | Water content | | | | | |
|---|---|---|---|---|---|---|---|---|
| | Feather | Water | in feather | Pressure | Temp. | Time | Mass | Concen. |
| KHP # | (kg) | (kg) | (%) | (kg/cm²) | (° C.) | (min) | (Da) | (ppm) |
| 1 | 70 | 0 | 46% | 13 | 180 | 40 | 705.9~3194.7 | 381250 |
| 2 | 50 | 40 | 50% | 12 | 185 | 80 | 593.3~3508.9 | 301500 |

A first embodiment of keratin hydrolysis peptide (KHP) solution, without water, can be made by 70 kg of feathers, with the feathers' water content being 46%, and then treated by the steps of:
a. stirring the feathers in a sealed container;
b. hydrolyzing the feathers in the container with a temperature and pressure setting of 180° C. and 13 kg/cm² for a duration of 40 minutes;
c. using a mass spectrometer to confirm the combination of peptides in the solution to contain at least 253 peptides as listed in the specification whereby their molecular masses are between 705.9 and 3,194.7 Dalton, and the concentration is in the range of 2.0×10⁵˜4.5×10⁵ ppm.

The keratin hydrolysis peptide (KHP) solution of the first embodiment is further filtered and concentrated to 381,250 ppm concentration.

The KHP solution of the second embodiment takes the steps of:
a. Preparing the KHP solution by mixing 50 kg of feathers whose content is 50% water with 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The KHP solution of the second embodiment is further filtered and concentrated to 301,500 ppm concentration.

The confirmation of some of the 253 peptides is further done by referencing the BIOPEP-UWM database.

To test the effectiveness of the method of promoting corn growth by application of KHP solutions under low temperature setting, the YuMeiJeng corn species was selected by the inventors to conduct experiments and tests.

Healthy seeds are screened and planted into 3.5-inch pots, one seed per pot. The pots are placed in climate-control rooms with 16 hours of day light and 8 hours of dark time. In addition to normal watering, common TaiFei 43 instant fertilizer was applied to the pots in accordance with common practice.

Corn's nutritional growth period, after germination, are divided into stages: VE (sheath leaf protruding above ground), V1 (first leaf collar visible), V2 (second leaf collar visible), V3 (third leaf collar visible), V4 (fourth leaf collar visible, with stem tip branching tissue underground), V5 (fifth leaf collar visible, with stem tip branching tissue above ground), etc.

The inventors set KHP solution's application manners of soil infusion (50 ml per pot) or leaf spray (0.8 ml to leaves) based upon the growth stages of the corn as set forth below.

First, the inventors conducted soil infusion after seeding based upon the conditions detailed in the following table:

| | | Temp (° C.) | Infusion (50 | |
|---|---|---|---|---|
| Group | Low Temp | (light/dark) | ml) to soil | Dilution ratio |
| Normal Temp | — | 25/23 | water | — |
| and environment | | | | |
| Low Temp Ck 1 | 0-5 days after | 18/18 | water | — |
| Low Temp Exp | seeding | | KHP-1 | 100x |
| 1A | | | | |
| Low Temp Exp | | | KHP-1 | 50x |
| 1B | | | | |
| Low Temp Ck 2 | 6-9 days after | 18/18 | water | |
| Low Temp Exp | seeding (VE | | KHP-2 | 100x |
| 2A | stage) | | | |
| Low Temp Exp | | | KHP-2 | 50x |
| 2B | | | | |

For the normal temperature and environment group, the corns are given day light temperature of 25° C. (light amount of 27,000 Lux) and dark time temperature of 23° C.

For the corn pots in the low temperature check group 1 (Low Temp Ck 1), immediately after seeding, 50 ml of water was given, and are then given 5 days' low temperature treatment (18° C. for both day light and dark time). After the 5 days, the temperature is reverted back to normal temperature setting.

The Low Temp Exp groups 1A and 1B are given the same low temperature treatment, but instead of 50 ml of water, they are given KHP-1 solution, diluted with water by volume at ratios of 100 (noted as 100×) and 50 (noted as 50×) respectively, by infusing into the soil.

For the low temperature check group (Low Temp Ck 2), the pots are similarly given 50 ml of water after seeding and the first 5 days after germination are given normal temperature. On the 6th to 9th day, during VE stage, they are given the low temperature treatment of 18° C. (light amount 27,000 Lux during day time) for four days, then the temperature is reverted back to normal setting.

For the Low Temp Exp 2A and Low Temp Exp 2B groups, the pots of corns are given the same temperature and lighting treatment as the Low Temp Ck2 group, but instead of given 50 ml water, the soil is infused with 50 ml's KHP-2 100× and KHP-2 50× solutions.

On the 13^{th} day after seeding, the inventors took various measurements to assess the bio mass, stem heights and widths, leaf SPAD value and surface area as noted below.

The inventors extracted and cleaned the root portions and took pictures. The plant heights and stem widths are measured. They used a digital scale (AP224X, Shimadazu) to measure the underground biomass and tabulated the findings. For the leaf's measurement, the inventors used a analysis tool WinFOLIA Pro LA2400 (Regent) to compute the leaf surface area; the inventors used SPAD 502 plus to compute SPAD values. The findings are tabulated into the figures herein.

The inventors experimented with the soil infusion of KHP solution when the corn experienced low temperature at two different times: immediately after seeding and immediately after germination.

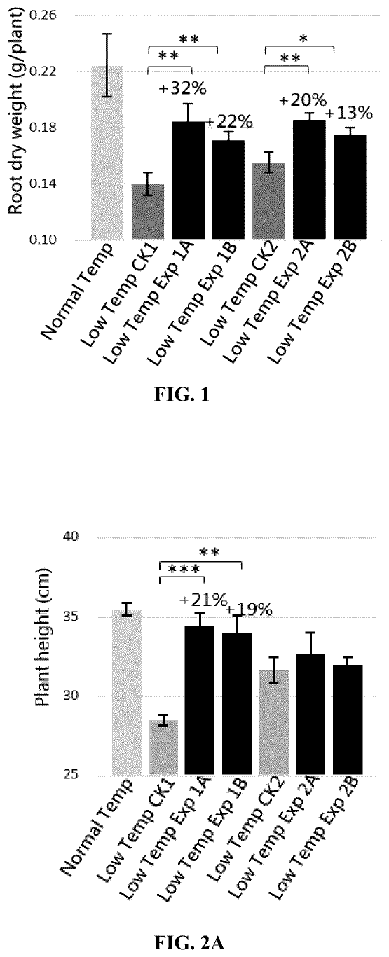

In FIG. 1, it can be seen that both low temperature check groups have much lower underground bio mass weights than the normal temperature setting group. But with the application of KHP-1 solutions (at either 100× or 50× dilution ratio), the bio mass weight increased substantially. The increase is between 22% and 32% in the Low Temp Exp 1A and 1B group; the increase is between 13% and 20% in the Low Temp Exp 2A and 2B group. The general observation in FIG. 1 is that lower concentration of KHP solution (the 100× group) performs better in promoting the corn growth in low temperature setting.

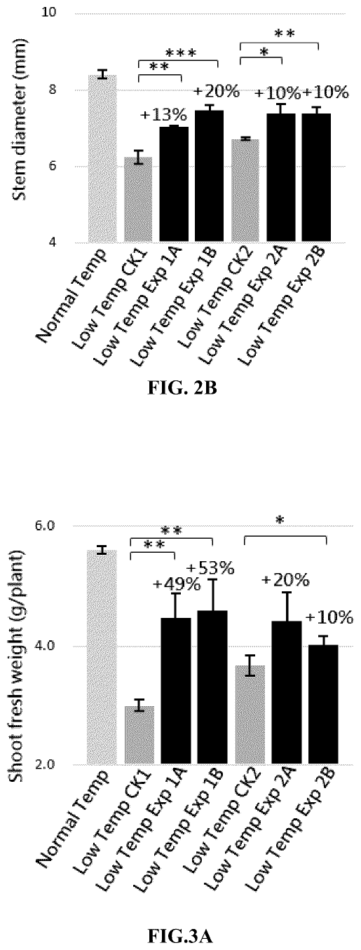

On the 13^{th} day after seeding, the heights in different groups are measured and noted in FIG. 2A. As shown, low temperature has huge impact on the height development of corn plants at seeding time, but less so in the VE stage. The increases in height in the Low Temp Exp 1A and Low Temp 1B groups are 21% and 19% over that of the Low Temp Ck 1 group respectively. The general observation in FIG. 2A is that KHP solution at lower concentration (the 100× dilution) works better to increase plant heights.

For stem widths, The Low Temp Exp 1A and Low Temp Exp 1B groups show increase of 13% and 20%, respectively, over that of the Low Temp Ck 1 group as reflected in FIG. 2B. The Low Temp Exp 2A and Low Temp 2B group both show 10% increase over that of the Low Temp Ck 2 group.

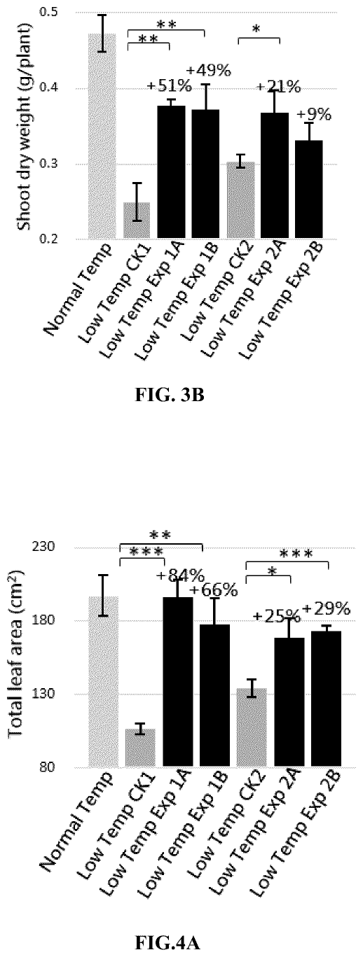

FIG. 3A shows the comparisons of fresh weights, among the two groups of low temperature treatment immediately after seeding and immediately after germination. The Low Temp Exp 1A and 1B groups show that the KHP solution infusion increased the above ground fresh weight by 49% and 53%, respectively, over that of the Low Temp Ck 1 group. The Low Temp Exp 2A and 2B group also show, respectively, 10-20% increase over that of the Low Temp Ck 2 group.

FIG. 3B shows above ground dry weight comparisons. The soil infusion of KHP solution to counter the low temperature stress showed that the Low Temp Exp 1A and 1B groups have 51% and 49% increase, respectively, over that of the Low Temp Ck 1 group. The Low Temp Exp 2A and 2B show increase of 21% and 9%, respectively, over that of the Low Temp Ck 2 group.

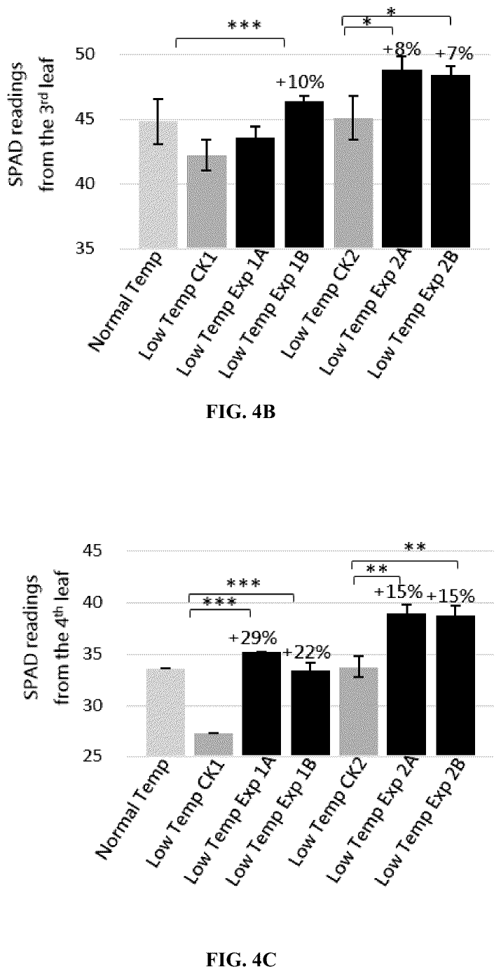

FIG. 4A shows the comparisons of leaf surface area. By the analysis done via WinFOLIA Pro LA2400 instrument, the inventors found that the leaf surface area of the Low Temp Exp 1A and 1B shows, respectively, 84% and 66%, increase over that of the Low Temp Ck 1 group. The Low Temp Exp 2A and 2B groups also show substantial increase of 25% and 29%, respectively, over that of the Low Temp Ck 2 group.

The inventors specifically measured the chlorophyll count by obtaining the SPAD values on the third and fourth leaves. The results are tabulated into FIG. 4B, showing the comparisons of SPAD reading for the third leaf and FIG. 4C, showing the comparison of SPAD reading for the fourth leaf.

In FIG. 4B, the soil infusion of KHP solution increased the third leaf's SPAD reading (reflecting chlorophyll count) over the corresponding low temperature check group by between 7% and 10%.

In FIG. 4C, the soil infusion of KHP solution increased the fourth leaf's SPAD reading over the corresponding low temperature check group by between 15% and 29%.

During the V3-V4 stages, the inventors applied to the corn plants by leaf spray, using 0.8 ml of KHP solutions to spray on the leaves, and also using 50 ml of KHP solution for infusing into the soil containing the corn plants. The conditions of the low temperature treatment and KHP application are noted herein:

| | Temp (° C.) | Application at | | Dilution |
|---|---|---|---|---|
| Group | Light/dark | V3-V4 | Applied with | Ratio |
| Normal Temp | 25/23 | Soil infusion | 50 ml water | — |
| setting | | | | |
| Low Temp | 18/18 | Soil infusion | 50 ml water | — |
| Ck3 | (V3-V4) | | | |
| Low Temp | | Leaf spray | 0.8 ml KHP-1 | 500x |
| Exp 3A | | | | |
| Low Temp | | Leaf spray | 08 ml KHP-2 | 500x |
| Exp 3B | | | | |
| Low Temp | | Soil Infusion | 50 ml KHP-1 | 100x |
| Exp 3C | | | | |

Corns in all group are given the general NPK fertilizer (20-20-20) by infusion to the soil during the early growth period of between the 7^{th}-14^{th} days.

On the 14^{th} day after the low temperature treatment, measurements are obtained regarding biomass weights, plant heights, stem widths, leaf SPAD reading and leaf surface area, etc. The results are noted and tabulated into the figures as further discussed herein.

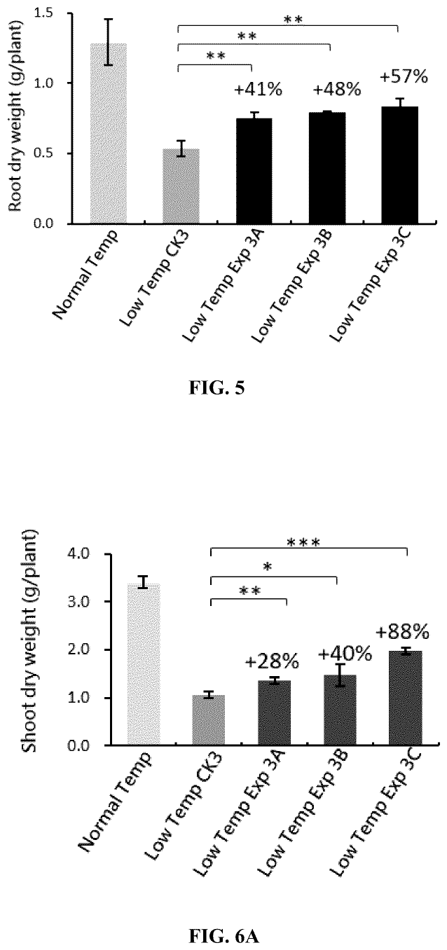

FIG. 5 shows the Low Temp Ck3 group's underground biomass weight is severely impacted by the low temperature. Such stunted growth, however, is greatly relieved by the method of KHP applications shown in the 3 groups with KHP treatments: Low Temp Exp 3A (leaf spray), Low Temp Exp 3B (leaf spray) and Low Temp Exp 3C (soil infusion).

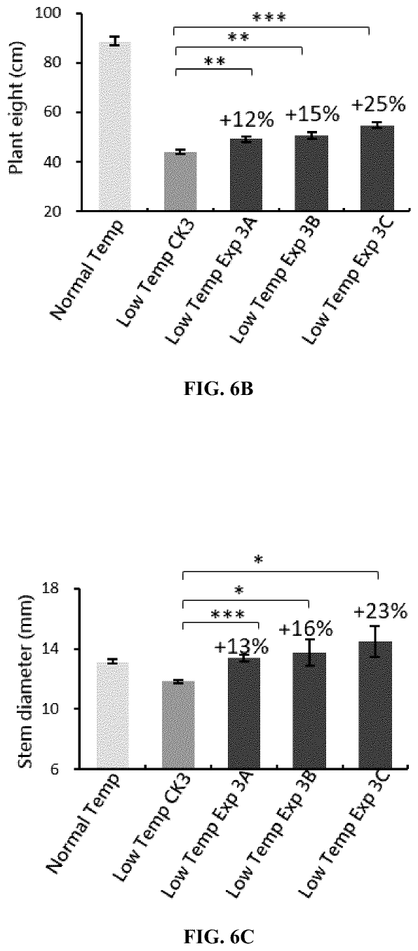

FIG. 6A shows the boost result of KHP solution to counter the low temperature stress, as evidenced in the above ground bio mass weights. The Low Temp Exp 3C group, with infusion of 50 ml KHP-1 100× solution, shows a whopping 88% increase over that of the Low Temp Ck3 group.

FIG. 6B shows the improvement of plant heights. All three KHP treatment groups show increase of between 12% and 25% over that of the Low Temp Ck3 group.

FIG. 6C shows the improvement of stem widths. All three KHP treatment group show increase of between 13% and 23% over that of the Low Temp Ck3 group.

The inventors measured the leaf development status of the corns in different groups and compared the leaf surface area, and SPAD readings from the 5th and the 6th leaves. The results are tabulated in the figures below.

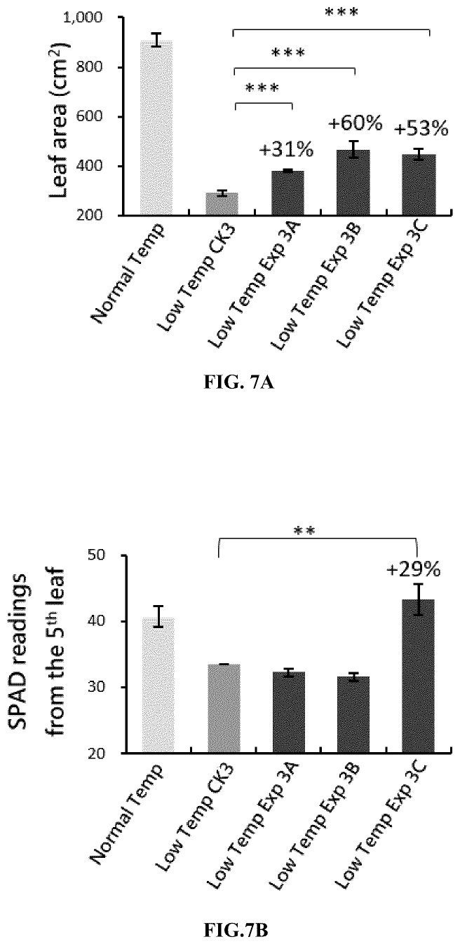

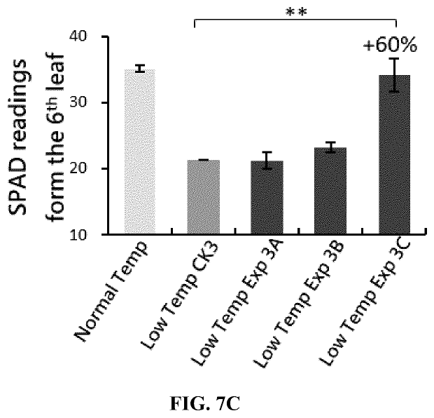

FIG. 7A shows the extremely poor leaf surface area in the Low Temp Ck3 group. With the application of KHP solutions as taught herein, the three treatment groups show increase of between 31% and 60% over that of the Low Temp Ck3 group.

FIG. 7B shows the comparison of SPAD readings from the 5th leaf among different groups. The soil infusion of 50 ml KHP-1 100× solution in the Low Temp Exp 3C group shows vastly improved result over that of the Low Temp Ck3 group, while the two other KHP treatment groups did not register positive result.

FIG. 7C shows the comparison of SPAD readings from the 6th leaf among different groups. Similar to the result in FIG. 7B, only the soil infusion of 50 ml KHP-1 100× solution in the Low Temp Exp 3C group shows substantial increase, by 60%, over that of the Low Temp Ck3 group, while the other two group did not register obvious positive result.

As has been proven by the tests conducted and verified via the scientific analysis/measurement done by the inventors, the method of creating the KHP solution and the method of application will promote the growth of corn under adversity of low temperature, and to reach the health conditions comparable to corns growing in normal temperature settings.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to promote the growth of corn under low temperature stress, comprising the steps of:
a. Preparing the KHP solution by putting 70 kg of feathers whose water content is 46%, without mixing any water, in a sealed container;
b. hydrolyzing the mixture in the container with a temperature and pressure setting of 180° C. and 13 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. Applying the KHP solution by first diluting with water by volume at the ratio of 1:50-100 before application.

2. The method of using a keratin hydrolysis peptide solution of claim 1 wherein the application of the solution is by infusing into the soil immediately after planting the corn seeds.

3. The method of using a keratin hydrolysis peptide solution of claim 1 wherein the application of the solution is by infusing into the soil at corn's seedling stage.

4. The method of using a keratin hydrolysis peptide solution of claim 1 wherein the application of the solution is by infusing into the soil at corn's V3-V4 growth stage.

5. The method of using a keratin hydrolysis peptide solution of claim 1 wherein the application of the solution is by leaf spraying to the plants at corn's V3-V4 growth stage.

6. A method of using a keratin hydrolysis peptide (KHP) solution to promote the growth of corn under low temperature stress, comprising the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. Applying the KHP solution by first diluting with water by volume at the ratio of 1:50-500.

7. The method of using a keratin hydrolysis peptide solution of claim 6 wherein the application of the solution is by infusing into the soil immediately after planting the corn seeds.

8. The method of using a keratin hydrolysis peptide solution of claim 6 wherein the application of the solution is by infusing into the soil at corn's seedling stage.

9. The method of using a keratin hydrolysis peptide solution of claim 6 wherein the application of the solution is by infusing into the soil at corn's V3-V4 growth stage.

10. The method of using a keratin hydrolysis peptide solution of claim 6 wherein the application of the solution is by leaf spraying to the plants at corn's V3-V4 growth stage.


SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS